(19) United States
(12) Patent Application Publication
(10) Pub. No.: US 2012/0296719 A1
(43) Pub. Date: Nov. 22, 2012

(54) System and Method for Providing a Pre-Paid Rebate Card

(76) Inventors: Mark Pearson, Edina, MN (US); Kelley Gregory, Shakopee, MN (US); Cletis D. Hoffer, Eden Prairie, MN (US); Joseph Custer, Minneapolis, MN (US)

(21) Appl. No.: 13/293,587

(22) Filed: Nov. 10, 2011

Related U.S. Application Data
(63) Continuation-in-part of application No. 11/748,201, filed on May 14, 2007.

(51) Int. Cl. G06Q 30/02

(52) U.S. Cl. 705/14.17

(57) ABSTRACT

A system and method for providing pre-paid rebate cards. A rebate offer may be provided to a consumer in relation to a particular purchase. The consumer may then submit a request for redemption of the rebate. A rebate processing center may validate the request for redemption from the consumer and notify a financial institution of the request. The financial institution may subsequently issue the pre-paid rebate card to the consumer. In the case of a reusable rebate card, the financial institution may subsequently add value in the amount of the rebate to a pre-existing reusable rebate card. The financial institution may further fulfill payment obligations upon consumer use of the pre-paid rebate card.

This application is a continuation-in-part of U.S. patent application Ser. No. 11/748,201, filed May 14, 2007, the content of which is hereby incorporated in its entirety by reference.

### FIELD OF THE DISCLOSURE

The present disclosure relates to the redemption of product marketing rebates. Particularly, the present disclosure relates to pre-paid rebate cards. More particularly, the present disclosure relates to systems and methods for providing pre-paid rebate cards to consumers, including a three-party agreement between a merchant offering a rebate, a rebate processing center, and a financial institution supplying pre-paid rebate cards.

### BACKGROUND OF THE DISCLOSURE

Commercial businesses are constantly looking for new ways to retain and/or increase client base. Product marketing rebates are well-known to most consumers and have been used by manufacturers as a tool for promoting and selling products by providing customers with an incentive to purchase particular products, sometimes during a specific period. Typically, in a rebate system, a consumer will purchase a product and subsequently submit a rebate claim for that product along with identifying information, such as the consumer's name, address, telephone number, e-mail address, etc. This criteria typically includes filling out a specific rebate form with the name and address of the consumer, enclosing a cash register receipt showing where and when the item was purchased, and sometimes enclosing the Universal Product Code (UPC) or other designated portion of the product packaging to show that the product was actually consumed. On receipt of the rebate claim and consumer identifying information, the manufacturer, or an agent of the manufacturer, such as a rebate processing center, will transfer the value of the rebate to the consumer. Thus, the consumer is provided with an incentive to purchase products having rebate offers.

Recently, commercial businesses have offered rebates in the form of rebate loyalty cards. In such methods, consumers submit a rebate claim as before. However, rather than receiving a check, the consumers receive a rebate loyalty card for the amount of the rebate that the consumer may use at the commercial business that offered the initial rebate. A drawback of the prior art rebate loyalty card systems is that a consumer must use the rebate card at a commercial business that is specified for them. Also, if several retailers were to issue rebate loyalty cards, the consumer's wallet or pocketbook would soon be bulging with rebate loyalty cards for every retailer they patronize, e.g., drug store, grocery store, electronics store, office supply store, toy store, department store, restaurant, etc. Thus, in many instances, the consumer is worse off with a rebate loyalty card than with a simple rebate check. Additionally, there is some financial burden on the retailer that is inherent in the administration of a loyalty card system. Similarly, the commercial business that initially offers a rebate will not likely want to financially support a rebate card program wherein the consumer can use the rebate at any location the consumer desires, such as any location that accepts payment by credit.

Therefore, there is a need for a system and method for providing pre-paid rebate cards to consumers that are easy for consumers to use and provide a pre-paid rebate card solution for rebate offers, wherein a three-party agreement between a merchant offering a rebate, a rebate processing center, and a financial institution supplying pre-paid rebate cards creates benefits for each party involved. There is also a need for a system and method for providing pre-paid rebate cards that provides benefits to consumers, financial institutions, rebate processing centers, and merchants There is further a need in the art for providing pre-paid rebate cards that are not limited to a single use, such that multiple rebates can be provided to the consumer using a single pre-paid rebate card.

### BRIEF SUMMARY OF THE DISCLOSURE

The present disclosure, in one embodiment, is a system for providing pre-paid rebate cards. The system comprises three entities. A first entity provides a rebate offer to consumers in relation to a specified purchase. A second entity validates rebate claims from the consumers and provides information relating to the requests to a third entity. A third entity issues pre-paid rebate cards to the consumers based on the information received from the second entity and further fulfills payment obligations upon consumer use of the pre-paid rebate cards. In some embodiments, the second entity may be an agent of the third entity. Furthermore, the second entity may provide to the third entity a monetary value of less than face value of the issued pre-paid rebate cards, and the first entity may provide to the second entity a monetary value of more than the value provided to the third entity by the second entity. In some embodiments, the value provided by the first entity to the second entity may be near, or equal to, face value of the pre-paid rebate cards. The third entity may retain slippage from nonuse of the total value of the pre-paid rebate cards. In further embodiments, the third entity may indemnify the first and second entities from risk and/or loss liabilities. The first entity may be a merchant, the second entity may be a rebate processing center, and the third entity may be a financial institution.

The present disclosure, in another embodiment, is a method for providing a pre-paid rebate card in response to a rebate claim from a consumer for a rebate offered by a first entity. The method includes providing information relating to the rebate claim to a second entity, wherein the second entity issues a pre-paid rebate card to the consumer and fulfills payment obligations upon use of the pre-paid rebate card by the consumer. The method further includes providing a monetary value to the second entity for a value less than face value of the pre-paid rebate card and receiving a monetary value from the first entity that is more than the monetary value provided to the second entity. In some embodiments, the monetary value received from the first entity is near, or equal to, face value of the pre-paid rebate card. In further embodiments, the method may include obtaining indemnification from the second entity from risk and/or loss liabilities. The first entity may be a merchant and the second entity may be a financial institution.

The present disclosure, in yet another embodiment, is a method for providing pre-paid rebate cards in response to a request from a first entity. The method includes receiving from the first entity a monetary value of less than face value of the pre-paid rebate cards, issuing pre-paid rebate cards to consumers based on information provided by the first entity, fulfilling payment obligations relating to consumer use of the pre-paid rebate cards, and assuming a portion or all of the risks and/or losses of the first entity. The method may further include retaining the monetary value associated with slippage in consumer use of the pre-paid rebate cards. The first entity may be a merchant or a rebate processing center.

In a further embodiment, disclosed herein is a system for providing a rebate, which may include: a rebate processing computer system having a processing instruction component configured to validate rebate information; and a rebate generation system configured to receive validated rebate information from the rebate processing computer system and thereupon: if the validated rebate information corresponds to a customer that does not already have a reusable rebate card, generate a reusable rebate card corresponding to the validated rebate information and if the validated rebate information corresponds to a customer that does already have a reusable rebate card, generate a request to add value to such reusable rebate card corresponding to the validated rebate information. A merchant may provide a rebate offer to one or more consumers in relation to at least one of a purchase of an item, a purchase of a plurality of items, and a purchase of a combination of items and provides rebate information to a rebate processing center operating the rebate processing computer system. Further, the rebate processing center may use the rebate processing computer system and the rebate information provided by the merchant to validate one or more rebate claims received from the one or more consumers and generates information relating to the one or more validated rebate claims. Also, a financial institution may receive the information relating to the one or more validated rebate claims and use the rebate card generation system to: in the case of consumers that do not already have a reusable rebate card, issue, to the one or more consumers, one or more pre-paid rebate cards based on the information relating to the one or more validated rebate claims and in the case of consumers that do already have a reusable rebate card, add value to such consumers' reusable cards based on the information relating to the one or more validated rebate claims. Additionally, the financial institution may further fulfill payment obligations upon use of the one or more pre-paid rebate cards by the one or more consumers.

In variations of this embodiment, the reusable rebate card may be provided in an open loop format. The reusable rebate card may be provided in a closed loop format. Or, the reusable rebate card may be provided in a format that is partially open loop and partially closed loop.

The reusable rebate card may have a media storage component configured to store information regarding a consumer. The media storage component may be a magnetic stripe. The information regarding a consumer may be demographic information configured for use with marketing purposes. The information regarding the consumer may be information regarding previous purchases made by the consumer. Furthermore, in some cases, the reusable card provides a suitable and/or cost effective manner for providing a rebate having a value that is less than the cost of generating a rebate card. The rebate card may also include a merchant indication on a face thereof.

In a further embodiment, disclosed herein is a method for providing a rebate in response to a request from a consumer for rebate redemption for a rebate offered by a first entity, which may include: using a rebate processing computer system having a processing instruction component configured to validate rebate information to receive and validate the request from the consumer for redemption of the rebate; providing information relating to the rebate redemption request to a second entity. Furthermore, the second entity: in the case of a consumer that does not already have a reusable pre-paid rebate card, issues a reusable pre-paid rebate card to the consumer and fulfills payment obligations upon subsequent use of the pre-paid rebate card by the consumer and in the case of a consumer that does already have a reusable pre-paid rebate card, adds a value to such reusable pre-paid rebate card and fulfills payment obligations upon subsequent use of the reusable pre-paid rebate card by the consumer.

In variations of this embodiment, the first entity may pay a fee for the provision of the reusable rebate card, or for the value addition to the reusable rebate card. The fee may be a fixed dollar amount. Additionally or alternatively, the fee may be a percentage of a value of the rebate.

In yet a further embodiment, disclosed herein is a method for providing a rebate in response to a request therefor from a first entity, which may include: receiving from the first entity information relating to one or more validated rebate claims submitted by one or more a consumers; based on information provided by the first entity, using a rebate generation computer system to: in the case of a consumer that does not already have a reusable pre-paid rebate card, generate a reusable pre-paid rebate card by storing information related to the consumer and a rebate value to the reusable pre-paid rebate card and issuing the pre-paid rebate card to the consumer and in the case of a consumer that does already have a reusable pre-paid rebate card, add a value to such reusable pre-paid rebate card by storing information related to the rebate value to the reusable pre-paid rebate card; receiving from the first entity a first monetary amount; and fulfilling payment obligations relating to use of the one or more pre-paid rebate cards by the one or more consumers.

In variations of this embodiment, the rebate card may be configured to redeem the value of the rebate at only a single merchant's locations. The rebate card may be configured to redeem the value of the rebate at a plurality of merchant locations. The reusable rebate card may not expire. Furthermore, the first monetary amount may be a fixed dollar amount or a percentage of the rebate value. The rebate card may include a merchant indication on a face thereof.

While multiple embodiments are disclosed, still other embodiments of the present disclosure will become apparent to those skilled in the art from the following detailed description, which shows and describes illustrative embodiments of the disclosure. As will be realized, the disclosure is capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the present disclosure, it is believed that the disclosure will be better understood from the following description taken in conjunction with the accompanying Figures, in which:

FIG. 1 is a flow diagram of a system and method for providing pre-paid rebate cards in accordance with an embodiment of the present disclosure.

FIG. 2 is a flow diagram of a system and method for providing pre-paid rebate cards in accordance with another embodiment of the present disclosure, including portions that may not directly involve a consumer.

FIG. 3 is a block diagram representation of a three-party agreement for a system and method of providing pre-paid rebate cards in accordance with yet another embodiment of the present disclosure.

FIG. 4 is a block diagram representation of payment transfers of a three-party agreement for a system and method of providing pre-paid rebate cards in accordance with another embodiment of the present disclosure.

FIG. 5 is a flow diagram of a system and method for providing reusable, pre-paid rebate cards in accordance with a further embodiment of the present disclosure.

FIG. 6 is a flow diagram of a system and method for providing reusable, pre-paid rebate cards in accordance with the embodiment of FIG. 5, including portions that may not directly involve a consumer.

FIG. 7 is an example open loop card with a merchant indication thereon in accordance with one embodiment of the present disclosure.

### DETAILED DESCRIPTION

The present disclosure is a novel and advantageous system and method for providing pre-paid rebate cards to consumers. Pre-paid rebate cards shall include any debit or credit card, including Visa®, Mastercard®, Discover®, American Express®, or other credit card, loyalty card, smartcard, scannable device, or other card or device suitable for storing information relating to a pre-paid rebate card or rebate offer. Generally, the present disclosure may provide a rebate offer to a consumer in relation to the purchase of a particular product or combination of products, such as, for example, a computer, monitor, and printer combination, from a merchant or manufacturer offering the rebate. A consumer may then submit a request to a rebate processing center for redemption of the rebate. A consumer may submit a rebate claim by several methods, generally including, but not limited to, mail, electronically, or telephonically. Similarly, a consumer may submit a rebate claim in accordance with either a traditional paper-based rebate embodiment or a “paperless” rebate embodiment. The rebate processing center may, among other rebate processing, validate the request for redemption from the consumer and notify a financial institution of the request. The rebate processing center may select from a variety of rebate processing and validation systems and methods. The financial institution may subsequently issue the pre-paid rebate card to the consumer. The consumer may then use the pre-paid rebate card at generally any location. The financial institution may further fulfill payment obligations upon consumer use of the pre-paid rebate card. The present disclosure may generally include a three-party agreement between the merchant, the rebate processing center, and the financial institution. Furthermore, the agreement may provide for the financial institution to indemnify the merchant and the rebate processing center from at least a portion of the risk and/or loss associated with the present pre-paid rebate card system and method.

A pre-paid rebate card may offer several benefits to the consumer. A pre-paid rebate card may be easier to use than a rebate check. Additionally, a pre-paid rebate card of the present disclosure may allow the consumer to use the rebate card at generally any location that accepts payment by credit rather than only the initial merchant that offered the rebate. Furthermore, an unbanked consumer can avoid the hassle associated with cashing a rebate check at a financial institution, where, for instance, they might be charged a fee.

The present disclosure similarly provides several benefits to the parties involved, e.g., the merchant, the rebate processing center, and the financial institution. For example, the merchant may provide a more desirable rebate than that of traditional rebate offers without further cost to the merchant. The rebate processing center can avoid handling monetary transfers directly to the consumer upon rebate redemption and can further avoid handling monetary transfers to outside merchants, where the consumer has used the pre-paid rebate card. The term “outside merchant,” as used herein, may include those merchants or other entities that provide goods and/or services that are not the same merchant as the merchant that offered the initial rebate to the consumer. The financial institution may benefit since it becomes a participant in consumer rebate programs. For example, the financial institution may receive income from slippage in consumer use of the pre-paid rebate cards. A further benefit includes the ability to track consumer spending habits through use of the pre-paid rebate card. Such information may be very helpful in designing better marketing and rebate programs for consumers. Through the collection of this type of data, merchants may identify specific individual consumers for targeted rebate offers, analyze general demographic trends among large groups of consumers, determine whether the pre-paid rebate cards are being used, determine where the pre-paid rebate cards are being used most, etc.

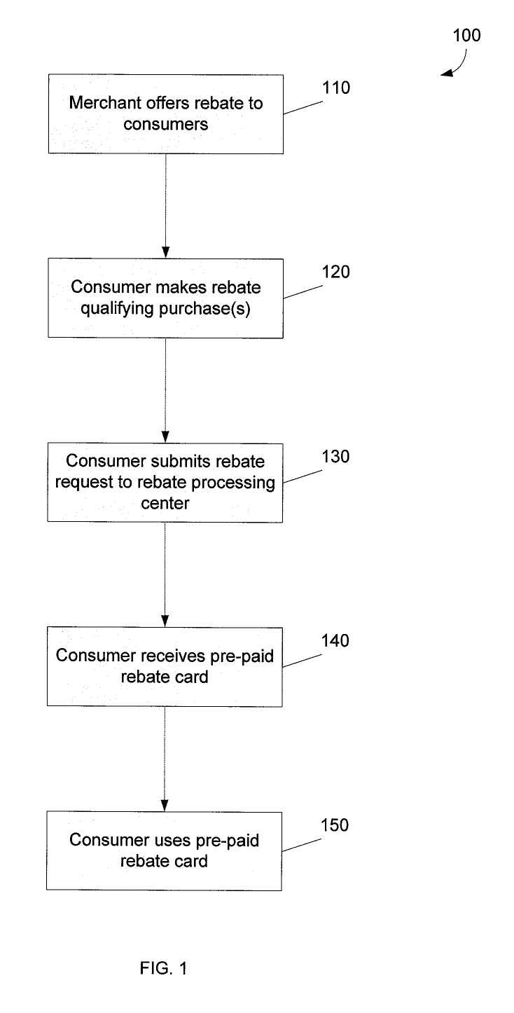

FIG. 1 illustrates a general pre-paid rebate card system and method 100 in accordance with one embodiment of the present disclosure. At step 110, a merchant may offer a rebate to consumers. In some embodiments, this may include notifying the consumer of the rebate offer. Typically, notification may be a written or oral communication indicating the terms of the rebate offer and instructing consumers with regard to satisfaction of the rebate offer. For example, consumers may be notified by a mass distributed flyer or advertisement. Such notifications may appear within printed or electronic media such as newspapers, magazines, journals and the like, internet publications or other internet websites, or any other advertising medium. Additionally, the notifications may be in the form of an email or delivered mail. Other forms of notification, such as oral communication or radio and television advertisements, are contemplated to be within the scope of the present disclosure. In some embodiments, consumers do not learn of the rebate offer until after entering a merchant's physical or internet location.

In some embodiments, a merchant may offer a rebate in situations where a consumer purchases a particular item, multiple items, or a combination of items, including items purchased in a single transaction or through multiple transactions, which may further occur on different dates. In other embodiments, a merchant may offer a rebate for any reason the merchant desires, such as a promotional rebate or a prize rebate. A merchant may include any product manufacturer or other business entity that provides goods or services to the public or other private or public entities.

At step 120, a consumer may make a purchase or multiple purchases that qualify the consumer for the rebate offered. Typically, the consumer may travel to a merchant to make a qualifying purchase. In other embodiments, it may not be necessary for the consumer to purchase the item or items at the merchant's physical location, and the consumer may purchase the item by other means, such as by mailing an order form or telephonically or electronically submitting an order. In a further embodiment, consumers may make a qualifying purchase in an electronic format, such as through designated sites connected to a global computer information network and accessible to the consumers through the global computerized information network. A global computer information network, such as the internet, may contain any number of websites that a user may access. Such websites may provide information for purchasing products and provide user interfaces through which users may transmit information about themselves, a product order, a credit card number, and the like.

Upon completion of a qualifying purchase, in some embodiments, a transaction may be recorded by a point-of-sale data processing and storage system. Typical point-of-sale data processing and storage systems may comprise a computerized system that receives purchase data either by manual entry by an operator or through scanning a Universal Product Code (“UPC”) supplied on the product packaging by either the merchant or the manufacturer. Often, the recording for each qualified purchase may include a transaction identifier or unique identification number (“UIN”). In one embodiment, the UIN may also be recorded on a receipt issued to the consumer. The receipt may be issued to the consumer directly, in the case of an in-store purchase, or electronically transferred to the consumer, in the case of an electronic purchase. An electronic receipt may be in the form of a transfer across a computer network, such as the internet. The point-of-sale data processing and storage system may be any system known in the art for recording and processing purchases at the point of sale.

In another embodiment, after making a qualifying purchase, consumers may be provided with a primary receipt and a secondary receipt. The secondary receipt may comprise a record of information associated with the qualifying purchase, including the UIN, whereas the primary receipt may consist essentially of information associated with all purchases, including items not associated with rebate offers. The secondary receipt may also contain information with regard to how consumers may perfect satisfaction of the rebate offer. In another embodiment, the information contained on the primary receipt and secondary receipt, as described above, may comprise a single receipt.

In some embodiments, the rebate processing center may receive reports from the point-of-sale data processing and storage systems comprising a plurality of purchase data records, e.g., information relating to the sales transactions for the merchant In one embodiment, a purchase data record may comprise a list of the products purchased by a consumer, the date of the purchase transaction, and the UIN. The purchase data record may include a list of all the products purchased during the transaction and not merely the products associated with a rebate offer. Alternatively, to minimize the purchase data report file size, the purchase data records may be limited to include only the purchased items associated with a rebate offer. The purchase data record may also comprise other data such as the store number, the purchase price of each product purchased, etc. In one embodiment, the report may comprise only those purchase data records having information relating to sales transactions including items associated with rebate offers. In a further embodiment, the rebate processing center may receive the reports electronically, in the form of a transfer across the internet or a tangible electronic storage device containing the electronic file. The report may also be delivered via mail or courier service. Additionally, the rebate processing center may receive the reports of purchase data items on a periodic basis, such as daily, weekly, or other suitable periodic basis. In other embodiments, the rebate processing center may receive the reports at non-regular intervals, such as dates specified by the merchant or rebate processing center.

Subsequently, the consumer may submit a rebate claim to a rebate processing center, as shown at step 130. A rebate claim may comprise the submission by the consumer of a rebate claim form. A rebate claim form may generally request transaction information, including the UN, and selected portions of consumer information. Additionally, a rebate claim form may include a destination address, rebate promotion information, and instructions for submitting material verifying the qualifying purchase, if necessary or desired. Consumer information may comprise any information that identifies or is associated with a particular consumer, such as the consumer's name, address, phone number, e-mail address, etc. Consumer information may also comprise of information regarding a particular consumer's more private information or lifestyle preferences and/or opinions, such as annual income, places where the consumer typically shops, items the consumer typically purchases, etc. Such information, if requested, may be useful in conducting consumer surveys and may typically be voluntarily offered by the consumer and not required to receive the rebate. Alternatively, in some embodiments, a rebate claim form may request only enough information to identify the consumer so that the rebate can be provided to the consumer.

In a traditional paper-based rebate system, a consumer may submit a rebate claim by recording personal information and qualifying UINs on a paper form and mailing the form to the rebate processing center. Although, the rebate claim may be submitted by recording the UINs on the paper form, in some embodiments, the consumer may submit the original receipts or copies of the receipts with the paper form for ease of validation.

In another embodiment, the rebate claim may be submitted by telephone. The consumer may place a call to a predetermined telephone number, which may, in some embodiments, be provided to the consumer by the merchant. In further embodiments, the predetermined telephone number may be provided on the receipt for the sales transaction. The predetermined telephone number may be connected to an interactive computerized telephone processing system, such as those used for voice-mail systems, customer service telephone lines, etc. In some embodiments, data requested by the interactive computerized telephone processing system may be received in the form of tones generated by the numeric keys of a touch-tone telephone. In other embodiments, voice recognition may be used to receive the data in the form of spoken response from the consumer.

In yet another embodiment, consumers may be able to access an electronic rebate claim form and submit an electronic rebate claim. For example, customers may be directed to a web page identified by a uniform resource locator (“URL”) and accessible using a web browser connected to the internet. The consumer may access the URL in several manners. In one embodiment, the consumer may access the URL using a menu option at the merchant's, manufacturer's, or rebate processing center's website. In some embodiments, the URL may appear to be the merchant's or manufacturer's website, but in fact be the rebate processing center's website that is merely linked to the merchant's or manufacturer's website. Additionally, the consumer may access the URL from any location. In one embodiment, the consumer may access the URL from a home computer system. Alternatively, the consumer may access the URL from a computer located at the merchant's location, such as an in-store kiosk. An electronic rebate claim form, accessible via the internet, may request similar information to that of the rebate claim form described above in that it may typically request transaction information, including the UIN, and selected portions of consumer information, and may include a destination address, rebate promotion information, and instructions for submitting material verifying the qualifying purchase. Alternatively, in some embodiments, an electronic rebate claim form may request only enough information to identify the consumer so that the rebate can be provided to the consumer.

In some embodiments, before being issued to the consumer, all or a portion of the information requested on the rebate request form may be provided, for example, by the merchant offering the rebate. In one embodiment, such may be the case where a purchase of an item or combination of items was made at the merchant's store or over the internet, and the merchant subsequently provides the consumer with the rebate claim form. In such cases, much of the consumer information may already be provided, or pre-filled in, on the rebate claim form by the merchant as such consumer information may have already been provided to the merchant for purposes of effectuating the sale of the item or combination of items. Alternatively, none of the consumer information may be pre-filled in, and the consumer may be required to fill in some or all of the information requested on the rebate request claim personally.

The consumer may submit a rebate claim by mail, telephone, internet, or any other suitable means for submitting a rebate claim. In one embodiment, the merchant may provide the consumer with instructions for submitting the rebate claim. In some embodiments, the consumer may not be aware of the involvement of the rebate processing center and may submit the rebate claim to the merchant, e.g., by addressing the rebate claim to the merchant, electronically submitting the rebate claim at the merchant's internet website, etc. The merchant may then forward the rebate claim to the rebate processing center.

At step 140, in response to the rebate claim, the consumer may receive a pre-paid rebate card. As previously mentioned, a pre-paid rebate card in accordance with an embodiment of the present disclosure may include any debit or credit card, including Visa®, Mastercard®, Discover®, American Express®, or other credit card, loyalty card, smartcard, scannable device, or other card or device suitable for storing information relating to a pre-paid rebate card or rebate offer. In some embodiments, the pre-paid rebate card may be a pre-paid credit card. In further embodiments, the pre-paid rebate card may require activation subsequent to receipt of the pre-paid rebate card by the consumer. In some embodiments, the consumer may activate the pre-paid rebate card by telephone or electronically over the internet.

After receipt of the pre-paid rebate card, the consumer may use the pre-paid rebate card to purchase goods or services, as shown at step 150. In further embodiments, the pre-paid rebate card may be used at any merchant that accepts payment by credit, including the merchant that offered the initial rebate or other outside merchant. In some embodiments, the consumer may use the pre-paid rebate card a plurality of times until the value of the pre-paid rebate card has been substantially or completely used. For example, the consumer may make multiple transactions at multiple locations using the same pre-paid rebate card. The pre-paid rebate card may be, or may be similar to, a credit card, such that the pre-paid rebate card may be swiped in a credit card scanning device at the time of purchase and the pre-paid rebate card information may be automatically entered into the point-of-sale data processing and storage system. Alternatively, the pre-paid rebate card may contain a unique number, such as a credit card number, that an operator may manually enter into the point-of-sale data processing and storage system.

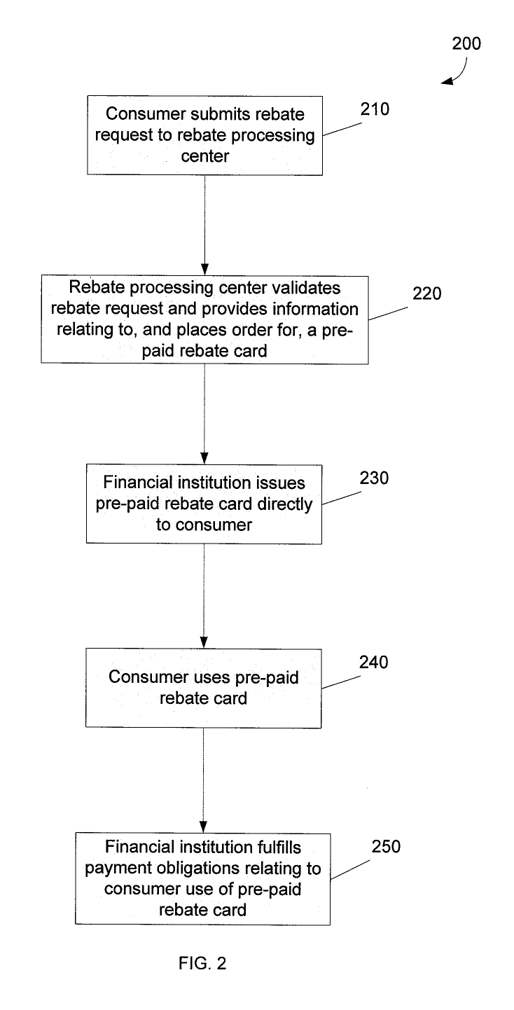

FIG. 2 illustrates a general pre-paid rebate card system and method 200 in accordance with one embodiment of the present disclosure, including portions that may not directly involve the consumer. In other words, FIG. 2 illustrates a general pre-paid rebate card system and method 200 including portions where the consumer does not directly participate.

At step 210, a consumer may submit a rebate claim to a rebate processing center, as was previously described in detail. The consumer may submit a rebate claim by mail, telephone, internet, or any other suitable means for submitting a rebate claim. In one embodiment, the merchant may provide the consumer with instructions for submitting the rebate claim. In some embodiments, the consumer may not be aware of the involvement of the rebate processing center and may submit the rebate claim to the merchant, e.g., by addressing the rebate claim to the merchant, electronically submitting the rebate claim at the merchant's internet website, etc. The merchant may then forward the rebate claim to the rebate processing center.

At step 220, upon receipt of the rebate claim, in some embodiments, the rebate processing center may verify that the rebate claim corresponds to a valid qualifying purchase. Validating rebate claims may be done in any manner known in the art, and no particular method of validation is particular to the system and method of the present disclosure. In one embodiment, a rebate processing employee may manually validate the rebate claim. In a further embodiment, the rebate processing employee may validate the rebate claim by verifying the UINs provided by the consumer, verifying the items purchased qualify for a rebate offer, verifying the purchase was made during the qualifying time period, if any, and/or verifying other purchase details, such as number of items purchased, valid receipt information, etc., to be sure that the rebate claim meets initial criteria. In another embodiment, the rebate processing center may employ a computerized software that matches the UINs provided by the consumer on the rebate claim with the UINs provided to the rebate processing center in the purchase data records provided in the point-of-sale data processing and storage system reports, described above. The computerized software may further validate the rebate claim by verifying the items purchased qualify for a rebate offer, verifying the purchase was made during the qualifying time period, if any, and/or verifying other purchase details, such as number of items purchased, valid receipt information, etc. The computerized software may also automatically calculate the rebate total based on the purchase data records. For example, the computerized software, in one embodiment, may automatically determine which items, or combination of items, from a purchase data record are associated with a rebate offer or rebate offers, and determine the total rebate value owed to the consumer. In some embodiments, the total rebate value owed to a consumer may be determined from the items purchased across multiple sales transactions evidenced by multiple purchase data records.

Hardware and software components used by the rebate processing center may be integral portions of a single computer or server or may be connected parts of a computer network. The hardware and software components may be located within the rebate processing center or may be operated offsite by a third-party subcontractor. In other embodiments, portions of the hardware and software components may be divided among a plurality of locations and connected directly or through a global computer information network, such as the internet.

Any combination of consumer identifying information, such as name, address, e-mail address, and the like and purchase identifying information, such as purchase location, purchase date, purchase item, and the like may further be used to validate the rebate claim in lieu of, or in addition to, the UIN. Alternatively, an operator may be employed to manually validate the rebate claims. Additionally, the rebate processing center may contact the merchant to verify that a qualifying purchase was made. The preceding examples of validation methods are meant only to provide examples of particular embodiments. The systems and methods of the present disclosure contemplate any form of validating a rebate claim. Similarly, the rebate processing center may bypass validation, or validation may be performed by another entity in lieu of the rebate processing center.

The rebate processing center may similarly check the rebate claims for fraud, for example, by comparing the name and address of the consumer to known databases containing consumer identities that may be suspicious or have previously been determined to act fraudulently. In other embodiments the fraud-checking step may be performed by an entity other than the rebate processing center or may be omitted entirely.

The rebate processing center may also provide information from a rebate claim to a financial institution. Information may be provided to the financial institution by mail, e-mail, or other electronic form, such as an electronic batch transfer, etc. In one embodiment, the information may be provided to the financial institution on a periodic basis, such as daily, weekly, or other suitable periodic basis. In other embodiments, the information may be provided to the financial institution at non-regular intervals, such as upon request by the financial institution. In a further embodiment, the rebate processing center may provide the information from a rebate claim with an order or request for the financial institution to issue a pre-paid rebate card. In other embodiments, the information may be provided separately from an order or request for the financial institution to issue a pre-paid rebate card. For example, the rebate processing center may place an order for a predetermined amount of pre-paid rebate cards for which the rebate processing center may later provide information that the financial institution can use to issue the pre-paid rebate cards. In other words, the rebate processing center may pre-order a bulk amount of pre-paid rebate cards for which the rebate processing center will subsequently provide information relating to which consumers the financial institution should issue pre-paid rebate cards.

As shown in step 230, the financial institution may supply and issue the pre-paid rebate cards. In a further embodiment, the financial institution may also print the pre-paid rebate cards. That is, the financial institute may imprint the necessary data, such as the consumers name and a unique card number, on the pre-paid rebate cards. In some embodiments, the financial institution may issue the pre-paid rebate cards directly to the consumers. The information the financial institution may use to issue the pre-paid rebate cards directly to the consumers (e.g., consumer names, addresses, etc.) may be provided with the information received from the rebate processing center. In further embodiments, the financial institution may be a federal bank.

After the financial institution issues the pre-paid rebate card to the consumer, the consumer may use the pre-paid rebate card to purchase goods or services, as shown at step 240. In further embodiments, the pre-paid rebate card may be used at any merchant that accepts payment by credit, including the merchant that offered the initial rebate or other outside merchant. In some embodiments, the consumer may use the pre-paid rebate card a plurality of times until the value of the pre-paid rebate card has been substantially or completely used. For example, the consumer may make multiple transactions at multiple locations. In some embodiments, before the consumer may use the pre-paid rebate card, the pre-paid rebate card may require activation by the consumer. In some embodiments, the consumer may activate the pre-paid rebate card by telephone or electronically over the internet.

When a consumer uses the pre-paid rebate card to purchase goods or services, the financial institution may fulfill payment obligations associated with consumer use of the pre-paid rebate card. Such obligations may be similar to those obligations with respect to the use of a credit card. For example, the financial institution may fulfill payment obligations to the sales merchant, the network supplying a connection between the financial institution and the sales merchant or other intermediary parties involved in the transaction, and/or the processor of the transaction, etc. In one embodiment, the total payment obligation for the financial institution for each pre-paid rebate card is at, or near, face value of the pre-paid rebate card.

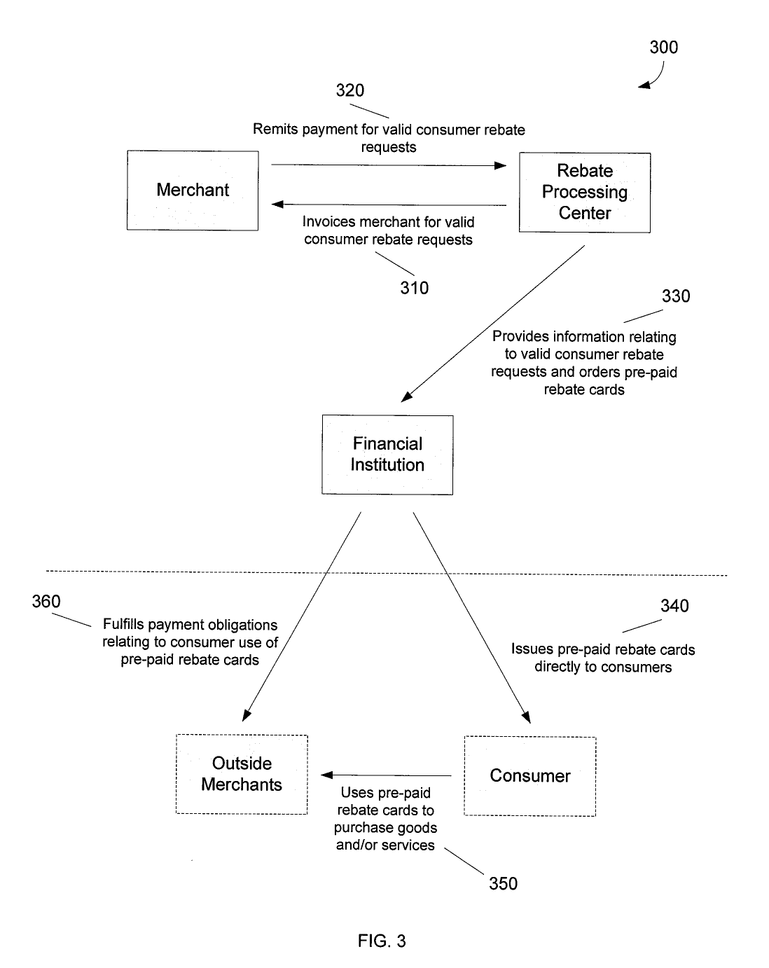

FIG. 3 illustrates a three-party agreement 300 for a system and method of providing pre-paid rebate cards in accordance with one embodiment of the present disclosure. The three-party agreement 300 may include a merchant offering a rebate, a rebate processing center, and a financial institution supplying pre-paid rebate cards. In some embodiments, the rebate processing center may be, or act as, an agent for the financial institution.

As shown in step 310, the rebate processing center may invoice the merchant for the value of the rebate claims submitted by consumers. In a further embodiment, the rebate processing center may invoice the merchant for the value of only the rebate claims that have been validated. As previously described, validating rebate claims may be done in any manner known in the art, and no particular method of validation is particular to the system and method of the present disclosure. Similarly, the rebate processing center may bypass validation, or validation may be performed by another entity in lieu of the rebate processing entity.

In addition to rebate claim validation, the rebate processing center may provide further services for the merchant, including but not limited to, providing the pre-paid rebate cards, rebate processing or other processing, customer service, and fulfillment of the pre-paid rebate cards (e.g., through the financial institution). In some embodiments, the rebate processing center may be a direct contact point for the merchant and provide the consumers of the merchant with pre-paid rebate cards and fulfillment services. In such an embodiment, the rebate processing center may contract out the services of issuing and fulfilling the pre-paid rebate cards to the financial institution. In other embodiments, the rebate processing center may act as an agent of the financial institution. In yet other embodiments, the services provided to the merchant by the rebate processing center may include customer service for the pre-paid rebate cards. For example, the rebate processing center may take customer service inquiries or telephone calls relating to problems during issuance of the pre-paid rebate cards, problems during activation of the pre-paid rebate cards, balance inquiries, etc. In other embodiments, the merchant or the financial institution may handle customer service issues.

The merchant, in response to the invoices received from the rebate processing center, may remit payment to the rebate processing center for the consumer rebate claims, as illustrated at step 320. In one embodiment, the merchant may remit payment to the rebate processing center for only those rebate claims which have been validated by the rebate processing center.

At step 330, the rebate processing center may provide information relating to the consumer rebate claims to the financial institution. Information may be provided to the financial institution by mail, e-mail, or other electronic form, such as an electronic batch transfer, etc. In one embodiment, the information may be provided to the financial institution on a periodic basis, such as daily, weekly, or other suitable periodic basis. In other embodiments, the information may be provided to the financial institution at non-regular intervals, such as upon request by the financial institution. In some embodiments, the information provided to the financial institution relates to only those consumer rebate claims that have been validated by the rebate processing center. Also as shown at step 330, the rebate processing center may order or request pre-paid rebate cards for the validated rebate claims. In one embodiment, the orders may be provided to the financial institution at the same time the information relating to the rebate claims is provided to the financial institution. In other embodiments, the information may be provided separately from the orders.

The financial institution, at step 340, may issue pre-paid rebate cards directly to the consumers based on the information provided by the rebate processing center. In other embodiments, the financial institution may issue the pre-paid rebate cards to the rebate processing center, which may then send the pre-paid rebate cards to the consumers. At step 350, the consumers may use the pre-paid rebate cards to purchase goods and/or services at any merchant, as was previously described. For example, the consumers may use the pre-paid rebate cards at any merchant that accepts payment by credit. Dashed lines surrounding the consumers and outside merchants are used to illustrate that the consumers and outside merchants are generally not participants of the three-party agreement between the merchant offering the rebate, the rebate processing center, and the financial institution supplying the pre-paid rebate cards. In some embodiments, however, the outside merchants or consumers may be part of agreements between the parties described herein.

In addition to issuing the pre-paid rebate cards, the financial institution may also fulfill payment obligations relating to consumer use of the pre-paid rebate cards, as shown at step 360. In some embodiments, the financial institution may fulfill payment obligations similar to those obligations with respect to the use of a credit card. For example, the financial institution may fulfill payment obligations to the sales merchant, the network supplying a connection between the financial institution and the sales merchant or other intermediary parties involved in the transaction, and/or the processor of the transaction, etc. In one embodiment, total payment obligation for the financial institution for each pre-paid rebate card is at, or near, face value of the pre-paid rebate card.

As previously stated, in some embodiments, the financial institution may be a federal bank. In further embodiments, the financial institution may assume at least some of the risks or losses of the merchant and/or rebate processing center arising from operation of the system and method described herein for providing pre-paid rebate cards and/or the three-party agreement, e.g., the purchase, marketing, and distribution of the pre-paid rebate cards, etc. In yet a further embodiment, the financial institution may assume a substantial portion of the risks or losses of the merchant and/or rebate processing center arising from operation of the system and method for providing pre-paid rebate cards and/or the three-party agreement. In other embodiments, the financial institution may indemnify the merchant and/or rebate processing center from, for example, liability under state consumer protection and privacy laws and statutory or common law fraud, embezzlement, theft, and conversion actions and proceedings, etc. In another embodiment, the financial institution may indemnify both the merchant and the rebate processing center.

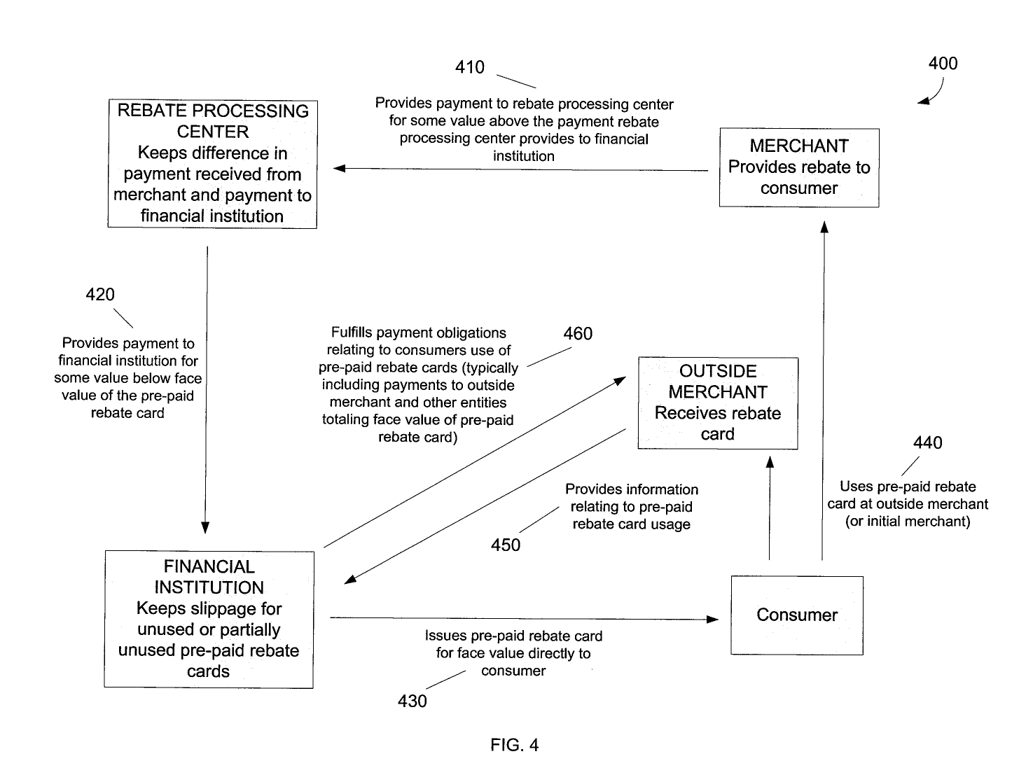

FIG. 4 illustrates a three-party agreement 400 for a system and method of providing pre-paid rebate cards in accordance with a further embodiment of the present disclosure. The three-party agreement 400 may include a merchant offering a rebate, a rebate processing center, and a financial institution supplying pre-paid rebate cards. In some embodiments, the rebate processing center may be, or act as, an agent for the financial institution.

As previously described, a merchant may offer a rebate to a consumer. As shown at step 410, the merchant may provide a monetary payment to the rebate processing center. In a further embodiment, the merchant may provide a monetary payment to the rebate processing center for some value above the monetary payment that the rebate processing center may provide to the financial institution for supplying and fulfilling the pre-paid rebate cards. In some embodiments, the merchant may provide a monetary payment to the rebate processing center for a value at, or near, face value of the pre-paid rebate cards. The payment to the rebate processing center from the merchant may include payment for, but is not limited to, the pre-paid rebate cards and software, hardware, or services associated with rebate processing, providing customer service, or other services the rebate processing center may provide throughout operation of the system and method provided herein. In other embodiments, the merchant may provide a monetary payment to the rebate processing center for a value below face value of the pre-paid rebate cards, such as where the rebate processing center provides only the pre-paid rebate cards to the merchant with fewer or no associated services. In yet other embodiments, the monetary payment to the rebate processing center may depend on certain economics of the operation of the system and method of the present disclosure and may be more or less than face value of the pre-paid rebate cards.

The rebate processing center may provide several services for the merchant, such as, but not limited to, providing the pre-paid rebate cards, rebate processing or other processing, customer service, and fulfillment of the cards (e.g., through the financial institution). In some embodiments, the rebate processing center may be, or act as, an agent for the financial institution. At step 420, the rebate processing center may provide a monetary payment to the financial institution. In a further embodiment, the rebate processing center may provide a monetary payment to the financial institution that is equal to some value below face value of the pre-paid rebate cards. In other embodiments, the rebate processing center may provide a monetary payment to the financial institution that is equal to, or above, face value of the pre-paid rebate cards and may depend on such things as economics, the agreement, what entity retains slippage revenue, etc.

The financial institution, in one embodiment, may print and issue the pre-paid rebate cards for the system and method of the present disclosure. As shown in step 430, the financial institution may issue the pre-paid rebate cards directly to the consumer. In some embodiments, the financial institution may retain slippage revenue associated with unused or partially unused pre-paid rebate cards. Rebate slippage may occur, for example, when consumers do not activate the pre-paid rebate cards, do not use the pre-paid rebate cards, or do not use the total value of the pre-paid rebate cards (e.g., when the consumer leaves a remaining balance on the pre-paid rebate card), etc. In other embodiments, the financial institution may provide the value, or portion of the value, associated with slippage to the rebate processing center, which in turn may provide the financial institution with a larger initial payment for the pre-paid rebate cards, including a payment of more than face value for the pre-paid rebate cards.

At step 440, the consumers, after receiving the pre-paid rebate cards, and in some embodiments activating the pre-paid rebate cards, may use the pre-paid rebate cards at any location that will accept the pre-paid rebate cards, such as any merchant that allows payment by credit. In some embodiments, the locations where consumers may use the pre-paid rebate cards include outside merchants or the merchant that initially offered the rebate to the consumers.

At step 450, a merchant where a consumer had used the pre-paid rebate card may provide information relating to the use of, or a transaction involving, the pre-paid rebate card to the financial institution. The information may be provided to the financial institution directly or indirectly, such as through a network provider and/or credit processor. At step 460, the financial institution may subsequently fulfill payment obligations associated with the transaction involving the pre-paid rebate card. In some embodiments, the payment obligations may include payments to the merchant involved in the transaction, a network providing communication between the financial institution and sales merchant or other intermediary party involved in the transaction, and/or the credit processor, etc. In further embodiments, the total payment obligation for the financial institution for each pre-paid rebate card is at, or near, face value of the pre-paid rebate card.

As previously described, in some embodiments, a rebate card may be provided to customers who are eligible for rebates in connection with the purchase of a particular product. Heretofore, rebate cards have been described with respect to a particular dollar amount, as applied to a particular rebate, where the dollar amount matches the rebate received by the customer. However, in some embodiments, the rebate card may be provided as a reusable rebate card. In such embodiments, the rebate card may be configured so as to accept additional amounts of value in connection with one or more additional rebate-eligible purchases, such purchases possibly occurring at the same time or at different points in time from the initial purchase or from each other. As such, the rebate card may function as a reusable store of value for multiple purchases wherein a rebate is received. In these embodiments, the rebate card may be thought of as “reloadable”, wherein an additional monetary value may be added to the card at any time, such as but not limited to, wherein the customer makes a rebate-eligible purchase.

Rebates provided in connection with a reloadable or reusable rebate card of the present embodiment may be subject to none, some, any, or all, of the previously described rebate validation processes. Further, it will be appreciated that any rebate provided in connection with a reusable rebate card may be subject to the same documentation, or evidence requirements, that rebates in accordance with the previous disclosure may be subject to. Of course, it will be appreciated that merchants providing rebates in connection with the presently described reusable rebate cards may require any amount of documentation to be submitted in any form, in connection with the provision of a rebate on such reusable rebate cards. Thus, rebates may be offered substantially instantaneously, where little or no verification is required, or, as with the previously described embodiments, it may take a length of time for rebate eligibility to be verified, possibly at a rebate validation center as described above, and thereafter associated with a reusable rebate card.

A reusable or reloadable rebate card account in accordance with the present disclosure may be provided in a variety of forms related to the customer's use of the value stored thereon. In one embodiment, the rebate card may be provided in a “closed loop” format. In these embodiments, the closed-format account is restricted to use for purchases from specific vendors. For example, a reusable card provider, such as a rebate card account manager or merchant, may issue a reusable card branded with respect to the merchant that is linked to a reusable account that will only distribute funds when the reusable card is used at a location of one of the specific merchants, or in some cases its website. The reusable card may also be authorized for use at subsidiaries or partners of the merchants.

In other embodiments, a reusable or reloadable rebate card in accordance with the present disclosure may be provided in a “open loop” format. In contrast to the closed-format account, an open-format account is not limited to specific merchants. Open-format prepaid instruments may be issued by or associated with a credit card processor such as but not limited to American Express™, MasterCard™, Discover™, or Visa™, etc.

Of course, it will be appreciated that a card provided in accordance with the present disclosure may be a combination of both the above-described open and closed formats, wherein the rebate card has aspects of both the open and close formats. For example, in one embodiment, a card may be provided wherein the card is usable at a specific subset of merchants, for example, merchants that have a promotional or other cooperative agreement with one another. In still further embodiments, the reusable rebate card may be redeemed for cash, check, or other form of currency, as opposed to use in connection with a purchase, wherein the user may receive the direct monetary value stored on the card from the aggregation of value of the one or more rebates received (or, it may be redeemable for less than the total value, as a fee for redeeming the rebates directly in cash).

In yet another embodiment, an open loop format card, or a partially open loop format card, may include an indication on the face (and/or backside) thereof indicating a particular merchant location, or plurality of merchant locations, at which the card is intended to be used. Such indication may include, for example, but is not limited to, words or phrases such as “use at Merchant X,” “for use at Merchant X,” “to be used at Merchant X,” “valid at Merchant X,” “accepted at merchant X,” and the like. In embodiments where an open loop card includes such an indication, while the user would not be limited to using the card at such merchant location (due to the aforementioned charateristics of open loop cards), the user may nontheless be more likely to use such card at the indicated merchant location than if there were no such indication present. This may allow a merchant to partner with an open loop card provider, such as American Express™, MasterCard™, Discover™, or Visa™, etc., to receive open loop cards for their merchant location that have all the aforementioned benefits of open loop cards (security, centralized processing, ease of reimbursement, etc.), yet are branded with an indication of the merchant location such that the user may use the card at the merchant location more often than if a regular open loop card were provided. As a result, partnerships may be established with card providers that allow the merchant to drive repeat sales at their location, colloquially known in the industry as “spend-back,” using such cards.

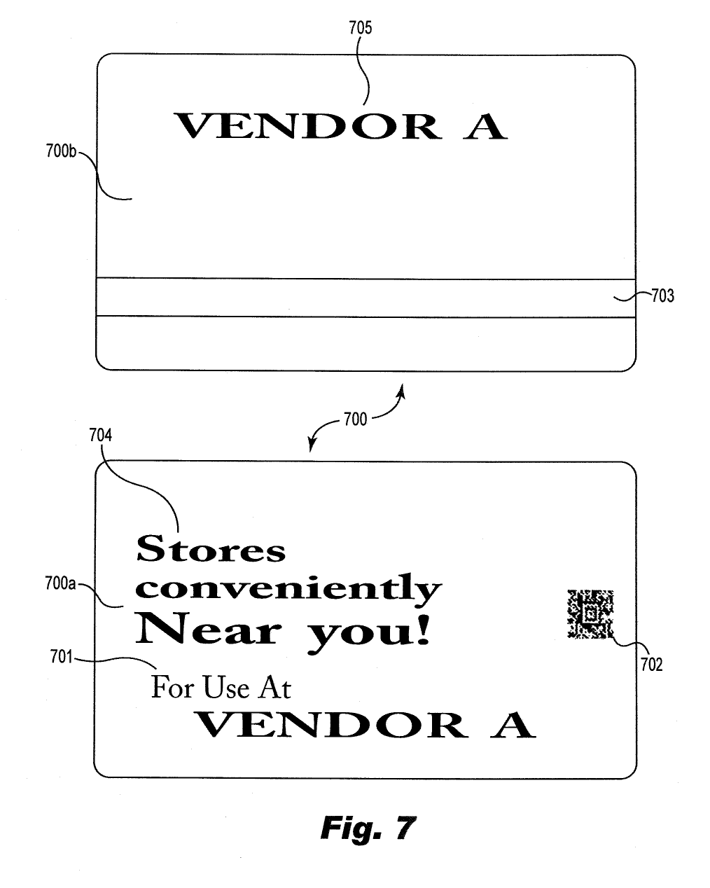

FIG. 7 depicts an example embodiment of an open loop card 700 with a merchant indication 701 printed on the face 700a thereof. As shown, the merchant indication includes the text “For Use At VENDOR A”. Examples of suitable cards for use with the present disclosure are disclosed in U.S. patent application Ser. No. 13/006,219, filed Jan. 13, 2011, entitled “System and Method for Providing a Rebate Card From a Kiosk,” which is incorporated by reference herein in its entirety. In the embodiment shown in FIG. 7, the face 700a of the card 700 may include an optical scanner code 702, such as, for example, a QR code as shown, and the back side 700b of the card may include a machine readable code 703, such as, for example, a magnetic stripe as shown. The card, of course, can include any other text or graphics as may be desired. In the embodiment shown, the face 700a of the card further includes the text “Stores conveniently near you!” (704), while the back side 700b of the card includes a merchant (vendor) name in text (705).

As further disclosed in application Ser. No. 13/006,219, in one embodiment, there may be an interrelationship between certain participants in the presently disclosed system, including a merchant, a rebate processing center, and a rebate card account manager. Of course, more or fewer participants may be included in other embodiments. In one embodiment, with regard to the merchant, in addition to other methods of rebate claim submission as discussed herein, the merchant may have an electronic kiosk or ATM associated therewith. The merchant may sell products that qualify a purchasing consumer to receive a rebate on such products. Upon purchase of a qualifying product, the merchant may provide the consumer with rebate information, which may be in the form of one or more rebate documents. The consumer may then use the ATM or kiosk associated with the merchant to submit a rebate claim, using the rebate information. Upon submission of a rebate claim, the kiosk or ATM may provide the consumer with a rebate card, for example an open loop rebate card 700, with merchant branding thereon, as discussed above, which in some embodiments may have a stored value thereon, and in other embodiments may be configured to receive a stored value at a later date.

The term value may generally be used herein as including a monetary amount in dollars or other currency, “points” or “credit” in a consumer loyalty program of a merchant, merchant association, or other association, or any other denomination of value which may be used to provide a rebate to a consumer. The reusable rebate card may have a unique identifier that associates the reusable rebate card with a customer to which it was issued. The format of the identifier may depend on the embodiment of the reusable rebate card, and may be an access code, a digital certificate, a printed receipt, a ticket, a scannable card, microchip, radio frequency identification (“RFID”), or other type of identifier associated with a media capable of storing the identifier. The identifier may be a number, a scannable symbol such as an Aztec Code or other barcode, or an electronic code such as that contained in a magnetic strip, microchip, or RFID. The instrument identifier may be a proxy number, which is typically used in credit card processing to protect the actual account number associated with a credit card. In one embodiment, the reusable rebate card may be a credit-card-size scannable card, having a scannable symbol representing the identifier number, and a magnetic strip for swiping at a point of sale.

In addition to such identifier, the storage media of the card, which may be, for example, a magnetic stripe, may include personal information regarding the customer to which such card was issued. The storage media provided on the rebate card may also be used to store a variety of information in connection with the provision of the rebate value. For example, information that may be stored on the storage media may include customer identity, customer address, customer phone number, customer preferences, customer associations, and other customer data that may be useful for marketing in association with the provision of rebates. For example, each time the reusable on the rebate card is used to make a purchase at one or more merchant locations, the purchase information regarding such one or more purchases may be stored and/or associated with the storage media on the rebate card, or otherwise stored on a database (which may be a, remote database, accessible by a network connection) such that the customer purchase information may be used for marketing purposes in connection with one or more merchants associated with the rebate card. As will be appreciated, customer data that may be stored on the storage media of the rebate card or stored at any other location may be used, in addition to the marketing purposes described above, with any other known marketing purposes, including but not limited to, direct sales via regular mail, e-mail, direct solicitation, data mining, and/or any other known methods of using customer information for marketing purposes.

In some embodiments, the storage media on the rebate card may be provided for customer-related functions beyond marketing. These additional functions include, for example, the provision of additional rebates, ID Card, customer or reward/loyalty programs, coupons or other non-rebate card associated promotional offerings, or other promotional offerings. In one example, wherein the reusable rebate card of the presently disclosed embodiment is used in association with a customer loyalty program, any purchases made with the rebate card may accrue value to said customer loyalty program. In a further example, a customer who is a member of a particular merchant's loyalty program may make a purchase using the reusable rebate card, having a value stored there on, wherein the amount of said purchase accrues a particular value to the customer loyalty program, for example, a certain amount of points for a particular dollar value of product or service purchased. In this manner, the rebate value stored on the reusable rebate card may be used not only to reload additional rebate values thereon or to purchase products or services from one or more merchants, but may alternatively or additionally be used to accrue value with a customer loyalty program at one or more participating merchants.

Of course, it will be appreciated that the storage media of a reusable rebate card in accordance with the present disclosure may be used in connection with one or more of the above described functions. For example, information stored on the storage media may be used both in association with a marketing program of one or more merchants and in connection with the customer loyalty program of such one or more merchants. Of course, the storage media (e.g., magnetic stripe) should not be limited to any particular use, but may be used in connection with any of the various above-described customer-related purposes.

The reusable rebate card may have a format that may allow a merchant to determine if the reusable rebate card is accepted by that merchant. As discussed above, reusable rebate card formats include: a single-merchant card that uses a closed-format account and is only accepted at a particular merchant; a merchant-chain card that uses a closed-format account and is accepted at merchants that are partnered according to certain criteria, such as commonly-owned restaurants or subsidiaries of “big box” retailers; or an open-format card that uses an open-format account and may be accepted at any vendor that has agreed to accept it, such as a prepaid Visa™ or American Express™ card being accepted anywhere that such payment device can be used. Reusable rebate card formats may also include any combinations of the above. The reusable rebate card may further be associated with unique incentives, such as product promotions or discounts on certain purchases. The reusable rebate card may also have a preset expiration date, or the expiration date may be set upon purchase. Alternatively, it may have no expiration date.

Embodiments wherein the rebate card is reusable or reloadable may be configured so as to accommodate the consolidation of rebates for one or more rebate sponsors. In particular, it will be appreciated that often times, rebates may be provided wherein it is un-economical to provide a rebate card solely in connection with that rebate. For example, the rebate card itself may cost the rebate provider an equal or greater amount than the value of the rebate, such as may be the case where the rebate is on the order of less than one dollar, or other small amount, which may be referred to herein as a “micro-rebate.” In such instances, it may be of value to employ a rebate card wherein the value of two or more rebates may be provided in connection with a single card. These two or more rebates may be provided by a single rebate sponsor, for example, a customer who purchases two or more rebate eligible products in a single merchant location may be provided with a single rebate card that is configured to store the value of such two or more rebates. Alternatively, the two or more rebates may be provided by two or more rebate sponsors, for example, a customer who purchases two or more rebate eligible products at two or more separate rebate providing merchants. Such purchases, in one embodiment, may be made at different times. In this manner, the rebate value associated with two or more multiple rebate eligible purchases may be associated with a single rebate card.

By way of example, it will be appreciated that rebates may be provided by various corporate entities, including, but not limited to, product manufacturers, product retailers, utilities, and others. Thus, in certain instances, it may be beneficial for such corporate entities to provide any rebates for which a customer thereof may be eligible, on a single rebate card. Thus, such corporate entities may engage in a business relationship with one another, or with a company that provides reusable rebate cards, such that any rebates for which customers of such corporate entities may be eligible can be provided on a single rebate card.

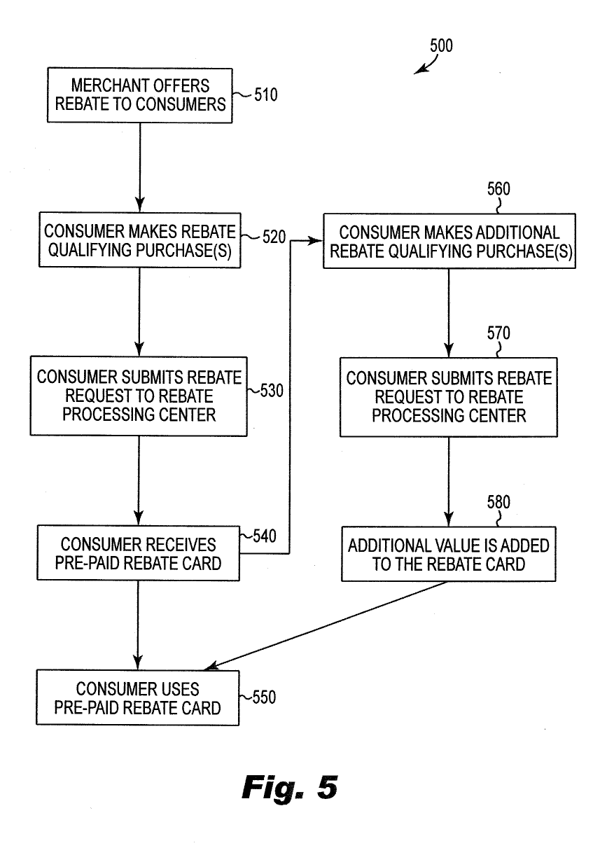

FIG. 5 depicts a flow diagram 500 of a system and method for providing reusable, pre-paid rebate cards in accordance with one embodiment of the present disclosure. In particular, blocks 510 through 550 may be substantially similar to blocks 110 through 150 in FIG. 1, with one exception being that the rebate card provided may be a reusable or “reloadable” rebate card as described above. Once that reusable rebate card has been received by the consumer at block 540, the consumer may make additional purchases that qualify the consumer for additional rebates, as shown at block 560. Thereafter, at block 570, the consumer may submit another rebate request to the rebate processing center regarding this additional rebate-eligible purchase, in a manner similar to block 530/130, as described above. Rather than sending another pre-paid rebate card to the consumer, additional value may be simply added to the existing rebate card in the amount of the validated rebate at block 580. The consumer can then use this additional value on the card to make additional purchases, as described above with regard to block 150/550.

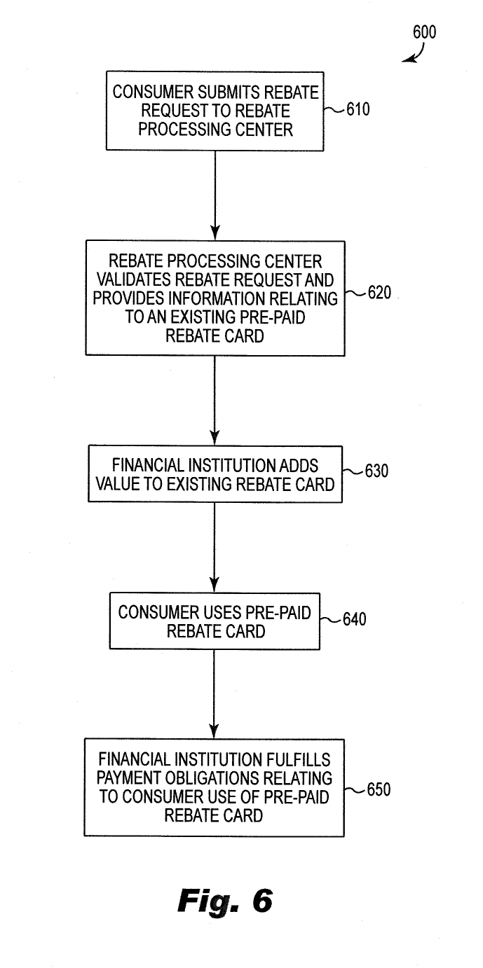

FIG. 6 depicts a flow diagram 600 of a system and method for providing reusable, pre-paid rebate cards in accordance with the embodiment of FIG. 5, including portions that may not directly involve a consumer. In this embodiment, just as with the embodiment discussed above with regard to FIG. 2, the consumer may submit a rebate request to the rebate processing center at block 610. Details of this submission procedure are discussed in greater detail above with regard to block 210 of FIG. 2. Thereafter, the rebate processing center may validate the rebate request in the manner discussed above with regard to block 220 of FIG. 2, except that the pre-paid processing center may provide information relating to an existing pre-paid rebate card, which the consumer may have received from a previous rebate-eligible purchase. At block 630, the financial institution may add a value to the existing rebate card corresponding to the value of the validated rebate. Thereafter, the consumer may use the pre-paid rebate card, and the financial institution may fulfill the payment obligations relating to this use of the rebate card, in the manner as discussed above with regard to blocks 240 and 250 of FIG. 2.

With regard to either FIG. 5 or FIG. 6, or any other figure in this disclosure, it will be appreciated that a particular embodiment is disclosed, and that other embodiments may have more or fewer procedures, and that procedures may be provided in any order. Thus, these figures are to be understood as illustrative of a particular embodiment, and not limiting on the number or order of procedures depicted therein.

In contrast with previously described rebate cards, which may be only associated with a single rebate-eligible purchase, the reusable or reloadable rebate cards in connection with the presently described embodiments may not realize the same “slippage” (wherein less than the total value of a rebate card is ever used) or “breakage” (wherein none of the value of a rebate card is ever used) that such previously described pre-paid single-value rebate cards may experience. That is, a reusable rebate card may not be susceptible to the same under-use as a card that is only allowed a fixed value. As such, it will be appreciated that an alternate fee model may be required in connection with the use of such presently-described reusable rebate cards. In one embodiment, a merchant may pay the rebate card provider a fixed fee in connection with the provision of a rebate value on the reusable rebate card. For example, the rebate providing merchants may pay the rebate card provider a fixed percentage, or a fixed dollar amount, for every rebate provided. In other examples, the rebate providing merchants may pay a fixed or variable commission in association with the offering of a particular rebate wherein the reusable rebate card is used to associate a value of such rebate. In still further examples, the merchant whereat a reusable rebate card is used by the consumer may pay a fee (fixed, percentage, etc.) of the purchase amount made by the consumer using the card. Other fee models, or combinations of the above-described models, are also possible.

The presently described reloadable or reusable rebate card may be particularly useful for retailers, for example, retail merchants, because the value of the rebate provided may be low enough in each instance such that the provision of a rebate card for each such instance may not be financially viable. However, the provision of a reloadable or reusable rebate card may allow such retail merchants to provide lower value rebates for the purchase of its products that otherwise would not be feasible with previously known rebate models. As will be appreciated, this may lead to the greater availability and use of rebates at a merchant location, which may in turn drive more traffic to such merchant location. For example, a retail merchant that desires to provide a rebate, which may be, for instance, in the value of one dollar or less, for a small value purchase, may likely not find it economical to provide a separate rebate card for each such purchase. However, where the retail merchant is able to simply add a value to a pre-existing rebate card, the retail merchant may then be able to provide a rebate in connection with such lesser value purchases via the rebate card.

As such, these “micro-rebates” may be afforded greater use wherein previously such small value rebates were not economical for a retail merchant, or other merchants, to provide the customer in a standard rebate fashion. Of course, such micro-rebates may be, and are currently, provided in an “instant rebate” format, wherein the rebate amount is immediately deducted from the purchase price at the point of sale. However, such instant rebates lack the verification procedures, as previously described, that are associated with rebates provided in accordance with the present disclosure. As such, presently described embodiments involving reusable rebate cards provide the benefit of allowing retailers desirous of providing rebates of low dollar denominations, for example, micro-rebates, the ability to verify the eligibility of such rebates, in contrast to existing instant rebates where verification is inherently limited.

Embodiments of the presently disclosed reusable rebate cards may provide certain benefits over known methods in the art, such benefits including the flexibility of delayed or immediate use of the rebate. For example, a customer who receives a rebate in connection with a rebate eligible purchase may use such rebate at any time within the timeframe associated with the reusable rebate card. For example, a rebate eligible purchase may be made, and a rebate value associated with such purchase stored on the reusable rebate card, and then, at a future date, the rebate value may be used to make a purchase using the reusable rebate card. Such future date may be substantially immediate, or it may be weeks, months, or years in the future. Thus, by associating a particular rebate value with a reusable card, the customer is not limited to a particular timeframe in which to use the rebates, as may be typical with single use rebate cards, or single rebate checks, as is currently known in the art. Therefore, reusable rebate cards provide the benefit of flexibility in connection with their use, more particularly the timeframe of their use.

In a further benefit, embodiments of the presently disclosed reusable rebate cards may allow a consumer to realize delayed or immediate rewards for purchasing a rebate eligible product. Specifically, because the rebate rewards are added to a single reusable rebate card, the consumer can decide when and how to use the rebate reward or combinations of rebate rewards, including how much of the combined rewards to use at any given time. In this manner, the consumer may build up “equity” on the reusable rebate card by making numerous rebate-eligible purchases at various times and/or various locations, each corresponding to an individual rebate value, and save such value equity for “delayed” use to make future purchases therewith.

Although the present disclosure has been described with reference to preferred embodiments, persons skilled in the art will recognize that changes may be made in form and detail without departing from the spirit and scope of the disclosure. For example, it is recognized that multiple embodiments of rebate validation or other rebate processing may be suitable for use with the system and method of the present disclosure. Similarly, it is recognized that the rebate claim may be submitted by the consumer in accordance with traditional paper-based rebate systems or “paperless” rebate systems.

We claim:

1. A system for providing a rebate comprising:
a rebate processing computer system having a processing instruction component configured to validate rebate information; and
a rebate generation system configured to receive validated rebate information from the rebate processing computer system and thereupon generate or reload a reloadable rebate card, wherein:
a merchant provides a rebate offer to one or more consumers in relation to at least one of a purchase of an item, a purchase of a plurality of items, and a purchase of a combination of items and provides rebate information to a rebate processing center operating the rebate processing computer system;
the rebate processing center uses the rebate processing computer system and the rebate information provided by the merchant to validate one or more rebate claims received from the one or more consumers and generates information relating to the one or more validated rebate claims; and
a financial institution receives the information relating to the one or more validated rebate claims and uses the rebate card generation system to: in the case of consumers that do not already have a reloadable rebate card, issue, to the consumers, one or more reloadable rebate cards based on the information relating to the one or more validated rebate claims and in the case of consumers that do already have a reloadable rebate card, add value to such consumers' reloadable cards based on the information relating to the one or more validated rebate claims;
wherein the financial institution further fulfills payment obligations upon use of the one or more reloadable rebate cards by the one or more consumers.

2. The system of claim 1, wherein the reloadable rebate card is provided in an open loop format.

3. The system of claim 1, wherein the reloadable rebate card is provided in a closed loop format.

4. The system of claim 1, wherein the reloadable rebate card is provided in a format that is partially open loop and partially closed loop.

5. The system of claim 1, wherein the reloadable rebate card has a media storage component configured to store information regarding a consumer.

6. The system of claim 5, wherein the media storage component is a magnetic stripe.

7. The system of claim 5, wherein the information regarding a consumer is demographic information configured for use with marketing purposes.

8. The system of claim 5, wherein the information regarding the consumer is information regarding previous purchases made by the consumer.

9. The system of claim 1, wherein the value of a rebate added to a reloadable rebate card is less than a cost of generating a reusable rebate card.

10. The system of claim 2, wherein the rebate card includes a merchant indication on a face thereof.

11. A method for providing a rebate in response to a request from a consumer for rebate redemption for a rebate offered by a first entity comprising:
using a rebate processing computer system having a processing instruction component configured to validate rebate information to receive and validate the request from the consumer for redemption of the rebate;
providing information relating to the rebate redemption request to a second entity, wherein the second entity: in the case of a consumer that does not already have a reusable pre-paid rebate card, issues a reusable pre-paid rebate card to the consumer and fulfills payment obligations upon subsequent use of the pre-paid rebate card by the consumer and in the case of a consumer that does already have a reusable pre-paid rebate card, adds a value to such reusable pre-paid rebate card and fulfills payment obligations upon subsequent use of the reusable pre-paid rebate card by the consumer.

12. The method of claim 11, wherein the first entity pays a fee for the provision of the reusable rebate card, or for the value addition to the reusable rebate card.

13. The method of claim 12, wherein the fee is a fixed dollar amount.

14. The method of claim 12, wherein the fee is a percentage of a value of the rebate.

15. A method for providing a rebate in response to a request therefor from a first entity comprising:
receiving from the first entity information relating to one or more validated rebate claims submitted by one or more a consumers;
based on information provided by the first entity, using a rebate generation computer system to: in the case of a consumer that does not already have a reusable pre-paid rebate card, generate a reusable pre-paid rebate card, associate information related to the consumer and a rebate value with the reusable pre-paid rebate card, and issue the pre-paid rebate card to the consumer and in the case of a consumer that does already have a reusable pre-paid rebate card, add a rebate value to such reusable pre-paid rebate card by associating information related to the rebate value with the reusable pre-paid rebate card;
receiving from the first entity a first monetary amount; and
fulfilling payment obligations relating to use of the one or more pre-paid rebate cards by the one or more consumers.

16. The method of claim 15, wherein the rebate card is configured to redeem the value of the rebate at only a single merchant's locations.

17. The method of claim 15, wherein the rebate card is configured to redeem the value of the rebate at a plurality of merchant locations.

18. The method of claim 15, wherein the reusable rebate card does not expire.

19. The method of claim 15, wherein the first monetary amount is a percentage of the rebate value.

20. The method of claim 17, wherein the rebate card includes a merchant indication on a face thereof.
